(19) United States
(12) Patent Application Publication
(10) Pub. No.: US 2007/0033412 A1
(43) Pub. Date: Feb. 8, 2007

(54) Communications device

(76) Inventors: Peter George Longman, West Midlands (GB); Christian Moray Jackson, West Midlands (GB)

Correspondence Address: Diane Dunn McKay;Mathews Collins Shepherd & McKay, Suite 306, 100 Thanet Circle, Princeton, NJ, 08540, US

(21) Appl. No.: 10/512,381

(22) PCT Filed: Apr. 24, 2003
(86) PCT No.: PCT/GB03/01750

§ 371 Date: Oct. 2, 2006

(30) Foreign Application Priority Data
Apr. 24, 2002 (GB) 0209353.2
Aug. 16, 2002 (GB) 0219185.6

(51) Int. Cl. H04L 9/00

(52) U.S. Cl. 713/182

(57) ABSTRACT

A communications device comprising a reader for reading a signal from a user, a communicator for generating a telephone call to a number, and a processor, in communication with the reader and communicator, adapted to instruct the communicator to call a specified number dependent on the signal received by the reader.

The present invention concerns devices that can be used for monitoring whether or not a person has reached or left one or more selected destinations.

Systems for such monitoring are known and are particularly useful in the expanding field of home caring. In the last few years there has been a substantial increase in the number of elderly or incapacitated people who live in their own homes and are reliant on regular visits by care workers. The care workers can belong to either local authorities or private organisations. In either case it is necessary for management to be able to monitor the staff who carry out the actual visits in order to ensure that the visits are both actually made and also importantly, made at the right time.

Before the arrival of Computer Integrated Telephony (CTI) such monitoring would normally be carried out on the basis of time logs filled in by individual staff. More recently systems have involved a user calling into a central office and inputting an identifying PIN number. A similar call on departure will identify the period at which the caller was at a particular address as Caller Line Identification (CLI) will supply the time, date and location of the calls. However such a system requires use of a clients telephone and can be subject to human error.

It is also known to identify a user by use of a smart card and reader such as a contactless proximity smart card reader. A contactless smart card reader requires no contact with the smart card and can read information from the card.

An object of the present invention is to provide a device which can monitor whether or not a person has reached or left one or more selected destinations identifying the person from information carried on them such as on a smart card.

According to a first aspect of the invention there is provided a communications device comprising a reader for reading a signal from a user, a communicator for generating a telephone call to a number, and a processor in communication with the reader and communicator adapted to instruct the communicator to call a specified number dependent on the signal received by the reader.

Embodiments of the invention will now be described, by way of example only, with reference to the accompanying drawings in which;

FIG. 1 is a schematic diagram of a system incorporating a communications device;

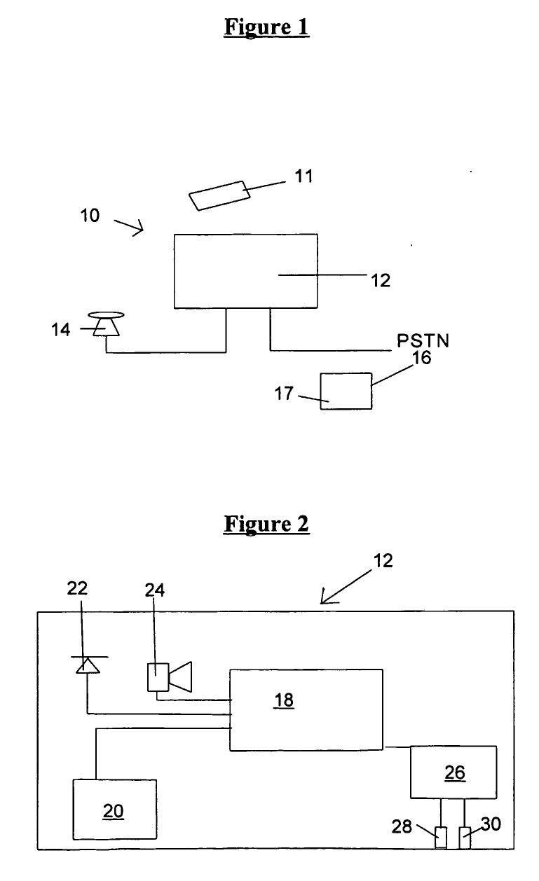

FIG. 2 is a schematic diagram of the communications device of FIG. 1;

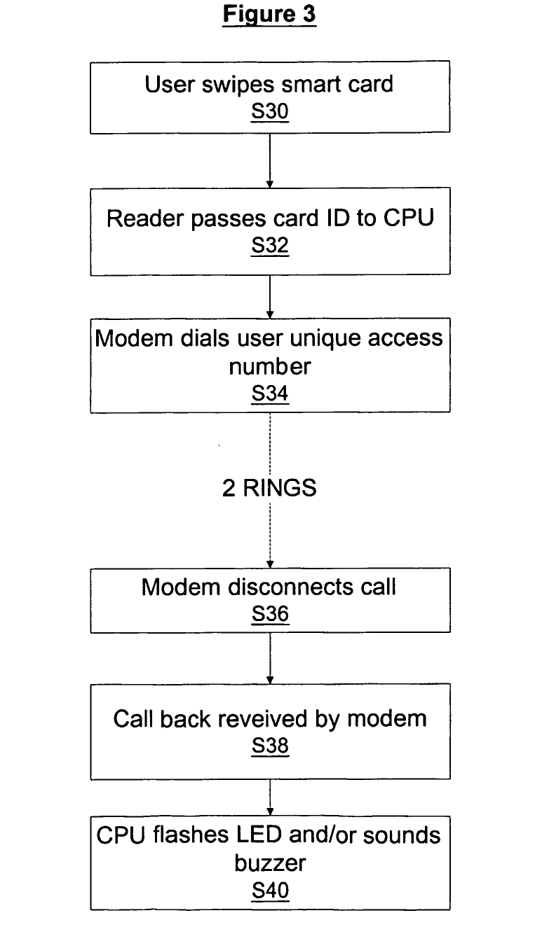

FIG. 3 is a flow diagram of a method of using the communications device of FIG. 1.

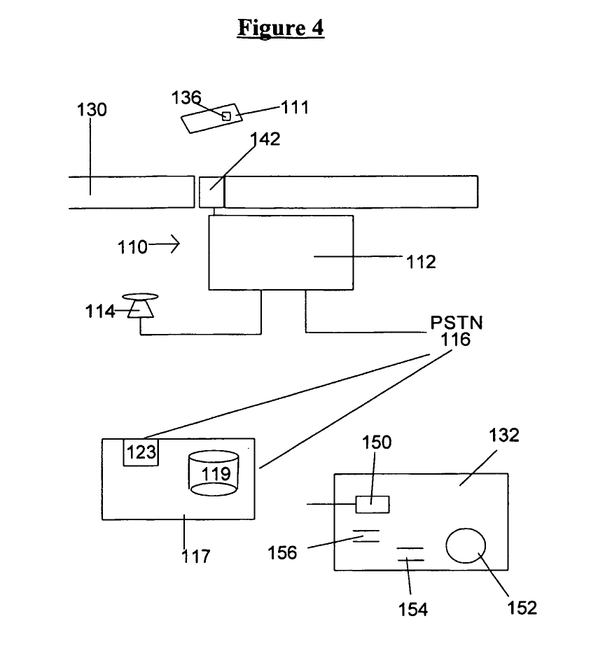

FIG. 4 is a schematic diagram of a second embodiment of a system incorporating a communications device;

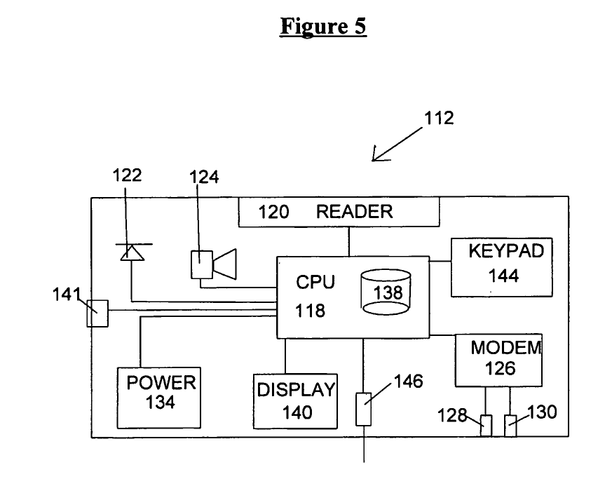

FIG. 5 is a schematic diagram of the communications device of FIG. 4;

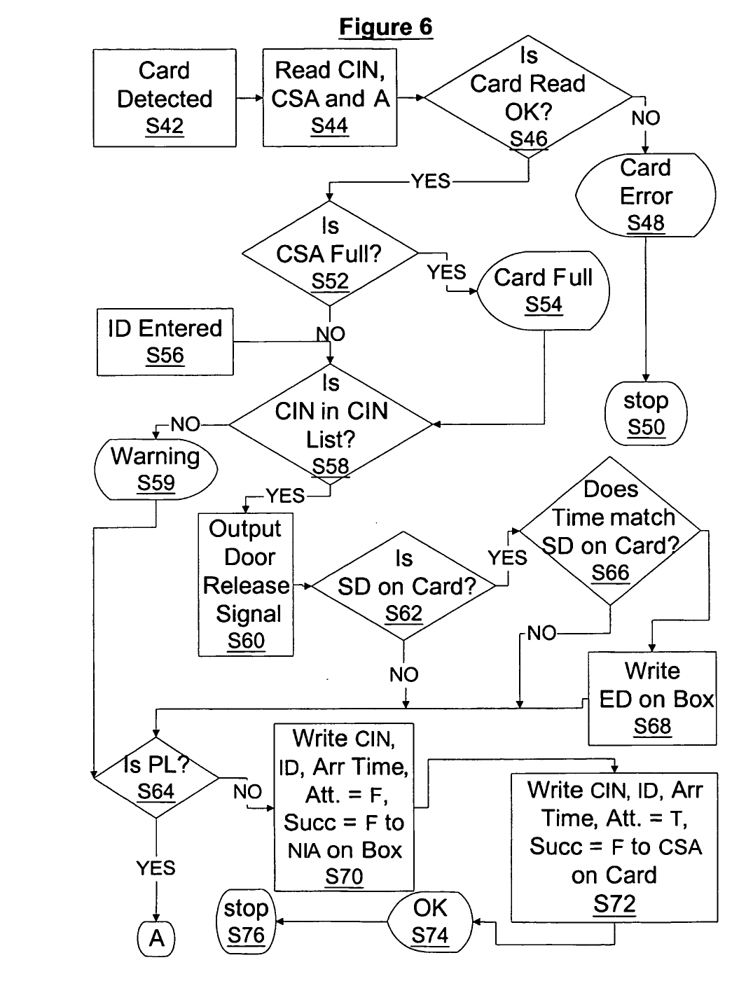

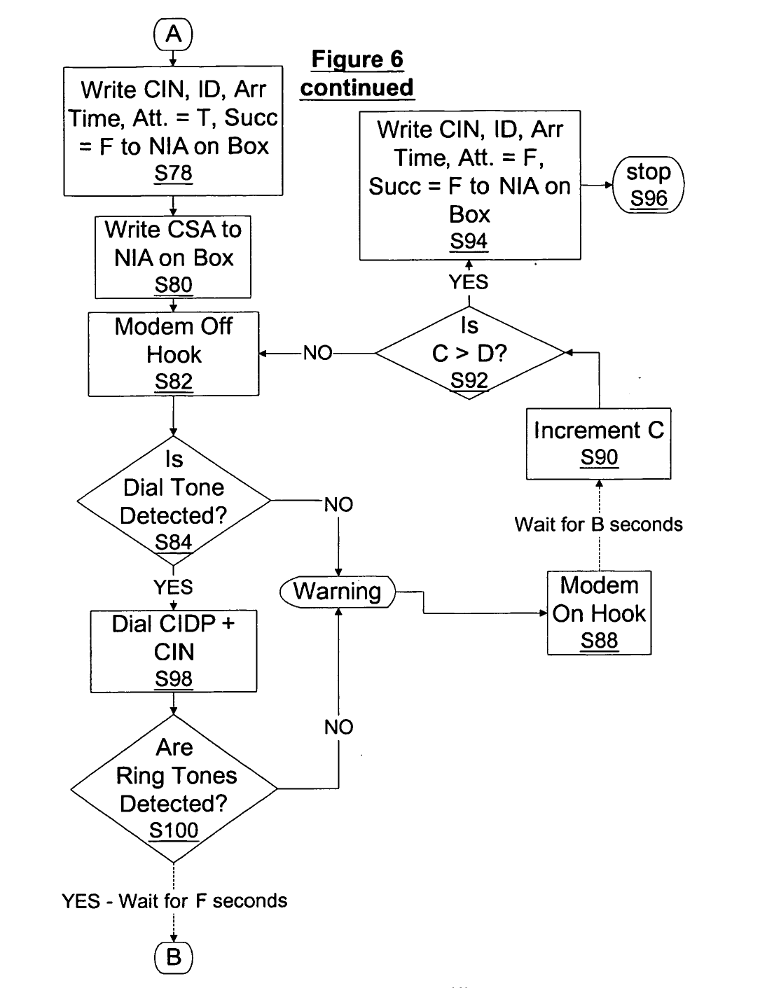

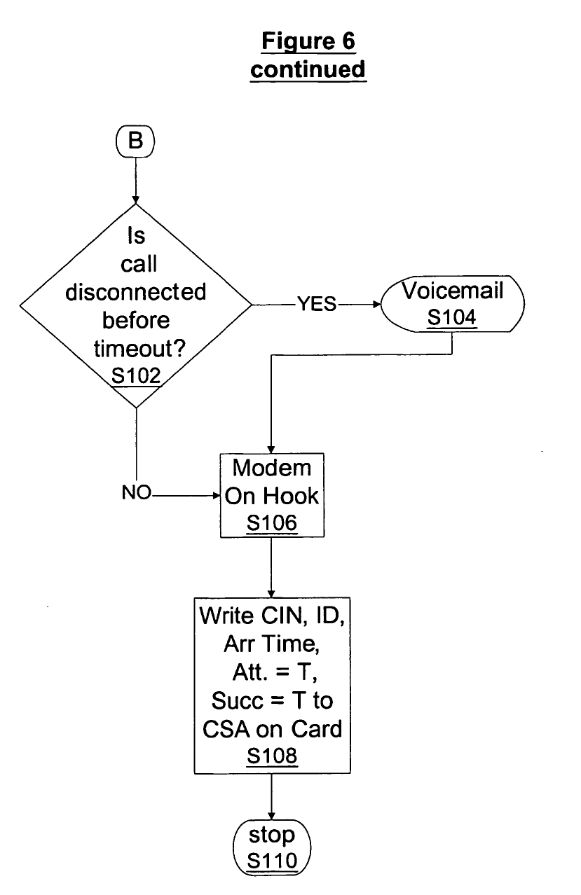

FIG. 6 is a flow diagram of a process of the communications device of FIGS. 4 and 5 detecting a smart card;

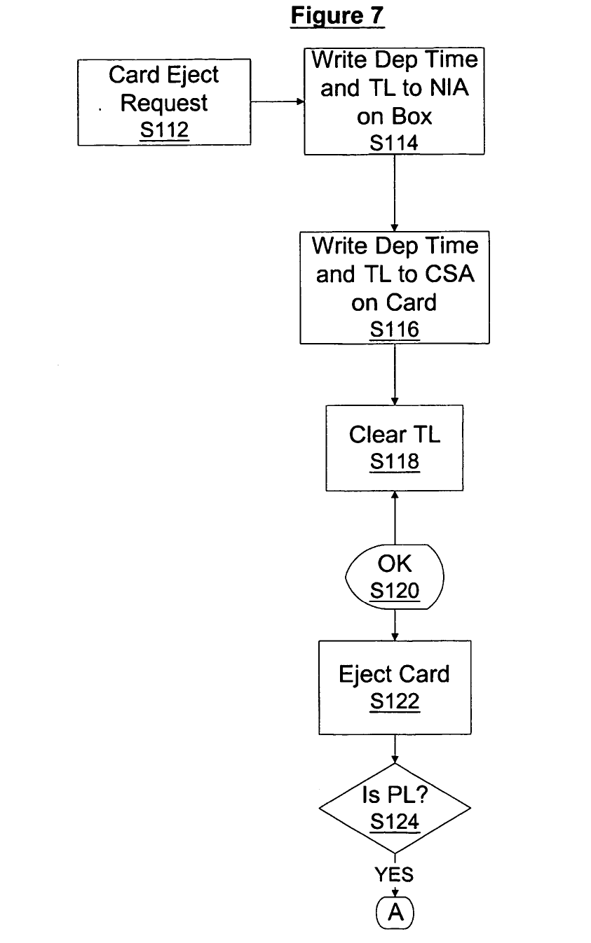

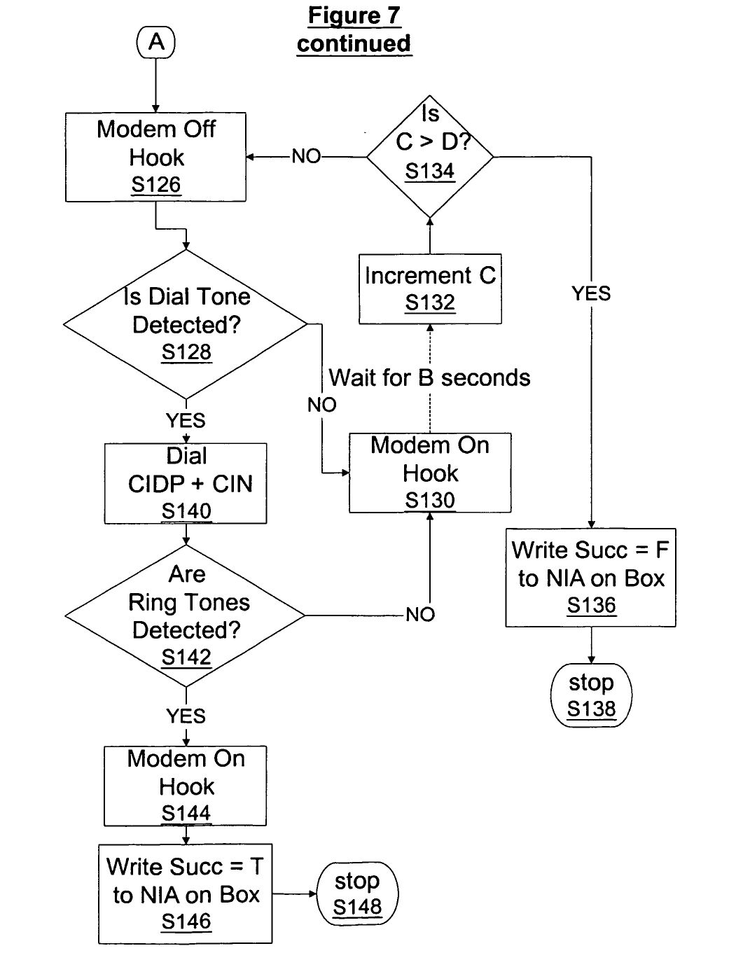

FIG. 7 is a flow diagram of a process of the communications device of FIGS. 4 and 5 detecting a smart card;

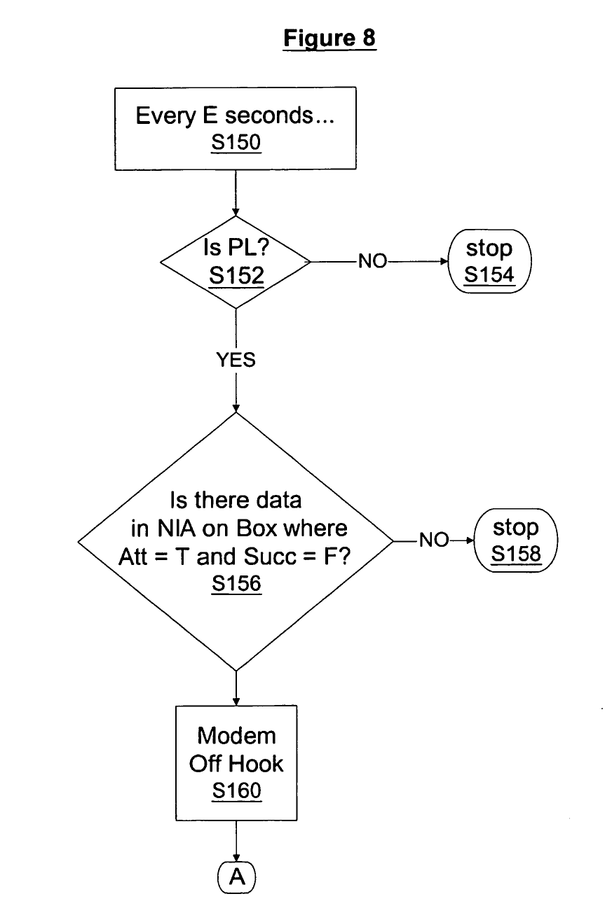

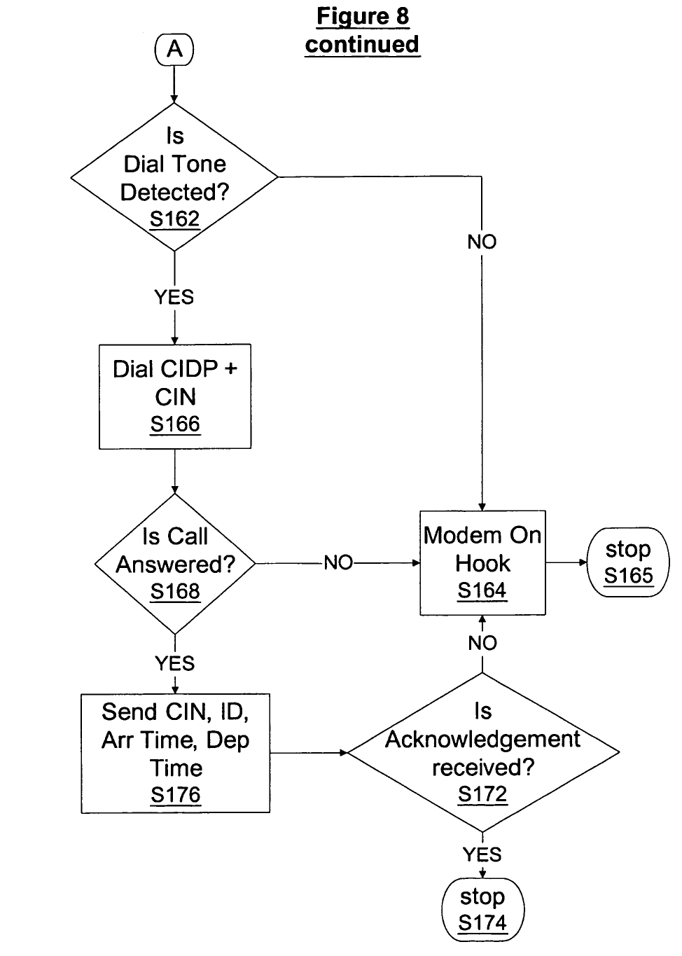

FIG. 8 is a flow diagram of the communications device of FIGS. 4 and 5 making retrospective calls.

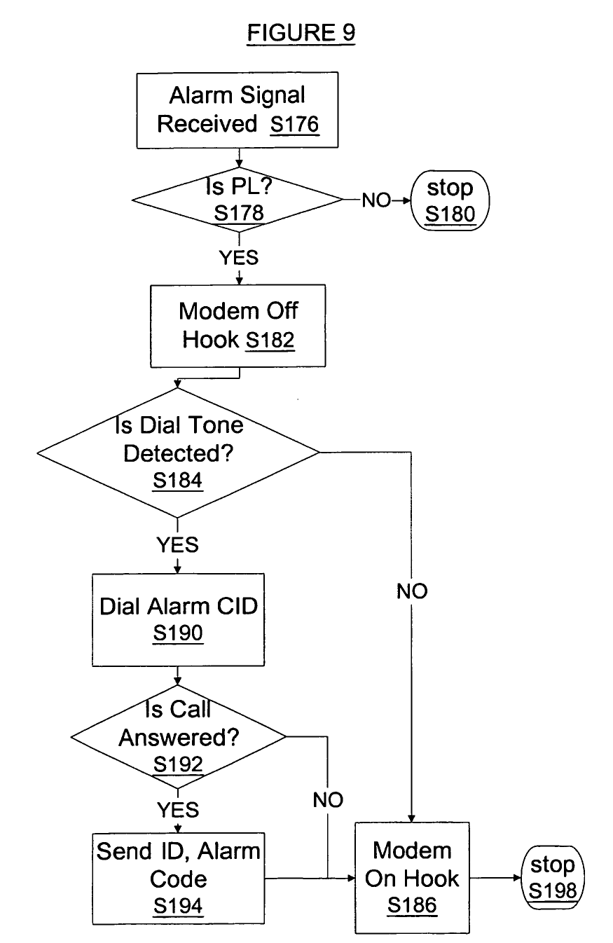

FIG. 9 is a flow diagram of the process of activating an alarm;

In FIG. 1 is shown a system 10 comprising a smart card 11 and a communications device 12, a telephone 14, a control centre 17 and a Public Service Telephones Network (PSTN) 16. The control centre 17 is connected to the PSTN 16 and the communications device is connected to the telephone 14 and the PSTN 16.

The smart card 11 comprises an antenna and circuit connected to the antenna and has a identification (ID) stored within it in the form of a unique signal or number for example. The smart card may be conveniently a similar size and shape to a credit card but could be embedded into other devices such as keys or watches. The smart card 11 may store information in a non-volatile memory on an embedded chip and need not have its own power supply or source.

As shown in FIG. 2 the communications device 12 comprises a Computer Processing Unit (CPU) 18 connected to a reader 20 a Light Emitting Diode (LED) 22, a buzzer 24 and a modem 26.

The reader 20 is preferably a contactless proximity smart card reader, though may also be a magnetic or swipe reader for example. A contactless proximity smart card reader is capable of reading information from the smart card 11 including the stored ID. In one embodiment the reader 20 comprises an antenna which transmits a radio frequency electromagnetic field. When the smart card 11 is brought close enough to the reader 20 the field generates an oscillating current in the antenna of the smart card. Circuitry in the smart card 11 can modulate the field, and the reader 20 then detects these changes in the field and can read the information such as the ID from the smart card 11.

The modem 26 has connection points 28 and 30, such as jack sockets, for connecting to the telephone 14 and the PSTN 16. The device 12 can be plugged in to a telephone socket using a standard adapter. The telephone 14 is connected, via a pass through connection in the modem 26 and it is not needed for use of the communications device 12 but allows a user to still use a telephone 14 that may normally be plugged into the telephone socket with the communications device 12 also plugged into the socket. Alternatively, the telephone may remain entirely separate from the device.

The CPU preferably has a memory which has a list of stored telephone numbers allocated to relevant smart card IDs. Alternatively the telephone number or Call In Number (CIN) can be stored in the relevant smart card 11 preferably in a Card Storage Area (CSA).

Device 10 could be incorporated within telephone 14.

Referring to FIG. 3 there is shown steps in a method of using the communications device 12. First a user inserts, swipes or places a smart card into, over or near the reader 20 (step s30). The stored smart card ID identifies the user, and this is read by the reader 20. The reader 20 then passes this ID to the CPU 18 (step s32). Next the modem 26 dials the telephone number corresponding to the ID read from the card (step s34). In an alternative form described above, the telephone number (CIN) is read from the smart card 11, passed to the CPU 18 and again dialled by the modem 16.

After a predetermined number of rings, such as two, or a predetermined time the modem 26 disconnects from the PSTN 16 (step s36). The modem 26 may then receive a call back for confirmation (step s38). Because the modem is dialling automatically and can detect ring tones a ring back call to confirm that a call has been logged is not a necessity. The modem can hang up as soon as ring tones are detected and the call would be complete. The call back may be advantageous over merely detecting the ring tones to confirm the call has been logged at the number that has been dialled.

After the modem 26 has either detected ring tones or received a call back the CPU 18 triggers an LED to be illuminated or buzzer sounded to inform the user that the process is complete (step s40). Illuminations and buzzers may be arranged to act in a number of permutations depending on the given set of conditions.

The device 12 may be used to monitor care workers. The device 12 in combination with a control centre 17 can remotely log a visit from a Service Users home.

Each care worker is supplied with a smart card 11 onto which is stored information including an ID and possibly a telephone number (CIN) uniquely identifying each care worker and preferably the Agency for which they work.

Each client to be visited can be supplied with a device 12 which can be plugged into their PSTN socket, along with their telephone 14 in series or parallel.

On entering a client's home, the care worker passes their smart card 11 in front of the reader 20 and the LED 22 acknowledges the presence of the smart card 11. The reader 20 then passes information to the CPU 18 from the card which includes a telephone number identifying the care worker to whom the card has been issued or an ID allowing the CPU 18 to find the telephone number from its memory. The CPU 18 then instructs the modem 26 to dial the telephone number and the modem 26 dials the number. The modem then waits until ringing tones are detected and hangs up after say 5 seconds. As confirmation that the call has been successfully recorded at the control centre 17, a ring back call may be made from the control centre 17 to the modem and the LED 22 (or a second LED in a different colour to the acknowledgement) illuminates or buzzer 24 is sounded. In this way the care worker can have confirmation that their whereabouts has been recorded. This feature has important implications in considering the safety & security of care workers in a lone working environment and clients potentially put at risk if their care worker fails to arrive on time.

The control centre 17 is capable of identifying the care worker from the number dialled. The centre 17 could have a separate telephone and telephone line for each number or could use DNIS (Dialled Number Identification Service) which can allow a single telephone line to provide a delivery point for multiple different dialled numbers or comparable system for example in a digital (ISDN) telephone exchange system. A database of clients and their telephone numbers can be used to ensure correct client identification for example by using CLI (Caller Line Identification).

The whole process would be repeated at the end of the visit prior to the care workers departure.

In FIG. 4 a more complex system 110 is shown that is particularly suitable for care workers in which components with similar functions to system 10 are labelled with reference numbers 100 greater than the corresponding component in system 10. System 110 will be described when set up for use for a care worker though it could be used in any instance when time recording is useful.

System 110 comprises a smart card 111, an alarm activator 132, a call centre 117 and a communications device 112 which device 112 is connected to a telephone 114, a Public Service Telephones Network (PSTN) 116 and a power supply 134. The communications device 112 can be located on the inside of a door 130 with the card 111 here depicted on the opposite side of the door 130. In contact with door 130 is also a door release means 142. A reader 120 forming part of communications device 112 can be located outside the door 130 depending on the readability of the circuitry of a card 111 by reader 120 in a particular location, for example a very large and or metallic door 130 render it very difficult for reader 120 to read card 111 when separated by such a door.

The smart card 111 comprises an antenna and circuity connected to the antenna and can be substantially similar to card 11 described above. The smart card stores information in a memory called the card storage area (CSA) 136 on an embedded chip and need not have its own power supply or source. Stored in the CSA 136 is the CIN (Call-In Number) of the care worker, the maximum time period (A) allowed for an outgoing unanswered call before the device 112 should time-out, an ID which is data representative of the device 112 which is preferably a unique alphanumeric sequence, and possibly some Scheduled Data (SD) such details relating to the timing and or times for scheduled visits by a carer to a client. The ID representative of an individual device 112 which can be stored on a smartcard 111 can usefully be used to cross-reference that a client is matched to the device 112 for example by comparison with schedule data and also CLI information. The ID can also usefully be used for example where a device 112 is not linked to a PSTN for a given client and accordingly the smartcard 111 is required to record all information regarding a visit to a client which information is then relayed to the call centre 117 from a separate device 112. Accordingly, the client which has been listed can be identified by the ID for the device 112 against which a visit was recorded.

The call centre 117 comprises a database 119 and a modem 123, the centre being connected to the PSTN 116 in the same manner as control centre 17 and additionally via modem 123. The database 119 contains the CINs and IDs for every care worker and device and is used to identify the carer, client and/or device 112 from a call made by a device 112. The call centre 117 can be used with a plurality of communications devices 112.

As shown in FIG. 5 the communications device 112 comprises a Computer Processing Unit (CPU) 118 with a memory 138, connected to a reader 120 a Light Emitting Diode (LED) 122, a buzzer 124, a modem 126, a display 140, an output 141 to door release means 142, keypad 144 and a radio antenna and receiver 146. As mentioned above, the reader 120 can be remotely located from communications device 112 and accordingly a port 121 (not shown) can be provided in device 112 for connection to a remote reader 120. Similarly, depending on the location of communications device 112 relative to a door 130, a port 141 can be provided for communication with a door release mechanism 142 or alternatively mechanism 142 can be located within device 112. The power supply 134 can be a rechargeable battery for example, one might also use a transformer and rectifying circuit connectable to mains electricity. Preferably, the rechargeable battery form of power circuit 134 enables device 112 to be recharged from telephone line voltage and or the device might be powered exclusively by telephone line voltage.

The reader 120 in this example is a contactless proximity smart card reader and is located adjacent to the surface of the door 130. When the smart card 11 is brought close enough to the reader 120 the field generates an oscillating current in the antenna of the smart card 111 in this case the field is large enough to create this current even when the card is at an adjacent position on the outside of the door 130 since known readers can read a card even through around 5-10 cm of wood. The reader 120 then detects these changes in the field and can read the information such as the CIN and A from the smart card 111.

The modem 126 works together with telephone 114 and the PSTN 116 in substantially the same way as modem 26 and is designed to be used with DNIS or similar system.

The overall telephony system used in system 110 is an ISDN system (Integrated Services Digital Network) or a comparable system. A feature of ISDN systems is that a user is able to purchase a number, which is free to the caller. Such numbers will be referred to hereinafter as “free call numbers”. Thus a caller dials the free call number and is then transferred to the call's final destination which bears the cost of the call rather than the caller. In addition ISDN supports what is known as DNIS (Dialled Number Identification Service). By means of the latter feature the recipient of a free call can not only, using CLI (Caller Line Identification), identify the telephone and thus the location from which the call was made but also identify the 0800 number to which the call was made. It is not essential to use free call (0800) numbers as unanswered calls will incur no charge to the call originator.

The present embodiment proposes that by utilising this DNIS feature together with the CLI information the caller can be identified unambiguously by the call centre 117 using database 119 without the need to answer a call. Thus each care worker is given his or her own individual free call number (CIN). This can be done because it is a relatively simple matter for an organisation to acquire a sequential batch of numbers so that each number can be allocated to a specific user.

Memory 138 in communications device 112 preferably stores a unique identification number (ID) for the device 112, an allowed CIN List, the relevant Caller ID Barred Removal Prefix, the total number of dial attempts allowed (D) to dial to raise an alarm (Alarm CIN) and possibly a task list (TL). Also in the memory 138 is a Non Immediate Area (NIA) for storing temporary information that does not need to be sent to a call centre 117 immediately. The CPU 118 also has a clock with the current time, which time can be entered by a user using keypad 144 or can be received by CPU 118 via modem 126 from the call centre 117. Indeed, such a mechanism can be used periodically to ensure that CPU 118 continues to use the correct time. In a similar manner schedule data (SD) and/or a task list (TL) can be received by the CPU 118 via modem 126.

Beneficially the clock enables the time of arrival of a user to be recorded at the start of a visit independent of whether or not a successful call is made by communications device 112 to a call centre 117 at the time of arrival. For example, communications device 112 might be unsuccessful in relaying the commencement of a visit to the call centre 117 immediately on the arrival of a carer since the client might already be on the phone or the phone line itself might have a temporary fault. In this case, the time of arrival is not the time the call is logged and hence it is necessary to correlate the actual time of arrival with the time of the logged call and this can be achieved by storing the actual time of arrival both within the communications device 112 for future transfer to the call centre and or in a user's smartcard 111 again for future transfer to the call centre 117. It should be noted that the clock within the communications device 112 may depend on an intermittent radio transmission device to maintain accuracy. Alternatively, the time recorded by communications device 112 can be by means of a relative rather than absolute time value. For example when a card is detected time equals zero and the information related to the elapsed time when a successful call is received at the call centre 117 is also transferred with the initial call and or an end of visit call thereby to enable determination of commencement times of visits, and visit duration.

The door release means 142 is particularly beneficial for care workers since clients of care workers often have difficulty in getting to and opening the front door. The door release means 142 is powered by power source 134 and can release a door locking mechanism (not shown) on the door 130 by passing electric current through a magnetic lock. Preferably the door release means 142 is activated by the device 112 successfully reading card 111 and therefore door entry and recording of the beginning of the visit can occur at the same time. For safety it is not desirable that any smart card 111 may gain access to a client's house and therefore it is preferable if the door release 142 is only activated if the CIN read from the card is one of the numbers stored in the CIN list. Only reader 120 need be located close to door 130 and the remainder of device 112 may be located remote from it connected to the reader 120 by cables.

There can be more than one reader 120 in total with possibly one or more readers 120 located on both the inside of and outside of the door 130. An inside reader 120 may be beneficial if for instance through habit a less frail client opens the door for the career before the card 111 has been read. An interior card reader could also be in communication with the door release means 142 such that the carer can exit by using his/her card 111 and record the end of the visit at the same time. More than one interior or exterior reader 120 could also be used to record multiple smart cards 111 simultaneously where more than one care worker is needed. It will be appreciated that it is possible for a user such as a carer to use a keypad 144 in order to gain access to a client's premises and or to actuate device 112 to commence recordal of a visit by entry of the carer identification number CIN via the keypad 144. However, this is not the preferred option but can be provided as an alternative if a user forgets his or her card 111. Preferably, the nature of the actuation of device 112 by a carer, e.g. by a use of a card 111 or manually through use of a keypad 144, is recorded by device 112 and can be transmitted to the call centre 117 with data related to the visit.

There can also be provided a change time function button allowing the carer to alter the start time to a different time to when the card 111 was read. This could be used if a care is delayed between entering the building and being able to insert/swipe his or her card 111. To reduce the risk of misuse any times altered using this change time function button will be highlighted as so changed to the call centre 117.

Display 140 can be used in conjunction with LEDs 122 and buzzers 124 to indicate events to a user, such as care worker or client, events such as a call being successfully recorded at the call centre 117, a warning to alert a carer if they have overstayed their time or errors occurring. The display 140 can be an LED or more preferably an LCD display which may give written messages such as “Call recorded”, “time overstayed” or “error” the name of the identified carer, or of a task the carer should undertake. In one form, the buzzer 124 and or a light such as LED 122 can be used to convey to the user that a message is waiting for them and that they should accordingly dial a predetermined number such as a free call number from the clients phone or alternatively they could call direct to the call centre 117 for example from a mobile phone. Alternatively, or in addition, display 140 can be used visually to display a message using speech to text recognition software or via data entry from a call to communications device 112. In a further form of conveying messages to a user, a system operator (employer, or call centre 117) can call the phone 114 at a client in order to deliver the message and accordingly CPU 118 is adapted preferably to enable all of these communication means with a user.

Keypad 144 enables a user to record additional information at the start or finish of a visit. In the case of a care worker this could be activities undertaken such as assisting the client out of bed, assisting the client with washing, making or assisting a client to make a meal and so on. The activities could be typed and stored as text but preferably a task List TL is stored in the memory 138 and has a present list of activities so that the carer can simply key a number or letter corresponding to one of these activities. The keypad 144 could alternatively be any suitable input device such as a mouse together with icons on a screen, or microphone together with voice recognition software. This information, can then be transmitted to the call centre 117. Such information could be sent by an answered call so rather than be sent with each end of visit, the information could be stored in the NIA of memory 138 and transmitted at a given time such as the end of a week or month. Alternatively, the nature of the task undertaken, could be transmitted using an unanswered call technology for example by assigning a series of numbers for each carer whereby the number called represented a task carried out by a specified carer. In another form, the number of calls within a specified period or the delay between two calls to a specified number might be used to indicate the nature of the task undertaken by a carer. For example, three calls within one minute to a specified number might indicate a given task whereas two calls within a minute might indicate another task. Alternatively, the time delay between two consecutive calls might be used whereby a delay of 30 seconds might represent one task and a delay of a minute might represent another task. Of course, the time separation between the two calls need not be exact and for example a 30 second delay might be deemed to have occurred if the second call is received between 15 seconds and 45 seconds of the original call (in other words plus or minus 50% of the specified time period).

In a preferred embodiment such information inputted by the care worker is sent as an answered data call to a data call line identification (DIN) separate from the standard CIN but also stored on the card 111 or in the memory 138 and identifiable using the ID. A list of all care worker DINs is also stored in the database 119. The DIN uniquely identifies each care worker in the same manner as the CIN but is sent to a different number at the call centre 117 which is answered by the modem 123 in order for information in the data call to be correctly identified. The CIN is used for calls that are to be unanswered, such as the calls made to signal the carers arrival and departure times. In this embodiment the device 112, therefore, has a data call mode in which a call is made to the DIN and an unanswered call mode in which calls are made to the CIN. The device automatically switches between modes depending on the nature of the call, being in the unanswered call mode when the care inserts, swipes or ejects the card 111 but switching to the data call mode when sending information stored in the NIA. Alternatively or additionally the device can have a switch which a care worker can use to manually switch between the modes. Alternatively the DIN need not be unique for each care worker, each DIN can be shared between several care workers in which case the care worker is identified from data sent as part of the data call.

Radio receiver 146 is used in combination with alarm activator 132. The alarm activator comprises a radio transmitter 150 and possibly a button 152 which when pressed switches on the radio transmitter 152 and sends a radio wave carrying an identification signal. The alarm activator 132 could also be connected to a conventional safety alarm such as a smoke or burglar alarm and the radio wave sent when this conventional alarm is activated. If the radio receiver 146 detects a radio wave with the correct identification signal the CPU 118 instructs the modem 126 to dial the Alarm CIN. In this way device 112 together with alarm activator 132 can be used as a social alarm and can call for assistance when the alarm is activated. Clients can keep the activator 132 about their person and activate the alarm should they fall or suffer any trauma. The activator 132 may also comprise a microphone 154 and loudspeaker 156 which would allow two way communication with the Alarm call centre which has been called by the Alarm CIN.

Referring to FIG. 6 the process of device 112 detecting a smart card 111 is shown. When the card 111 is held close enough to the reader 120, the card is detected, S42. The device 112 reads from the card 111 at S44 the CIN, the amount of remaining free space in the CSA and the present time-out period for an outgoing unanswered call (A). If there is an error in reading this information an error warning is shown to the user at S48, preferably via display 140, and the process stops S50. If no error has occurred the process continues to step S52.

At step S52 the device 112 calculates if the CSA is full and if it is displays a signal or message to the user at S54. In either case the process proceeds to step s58. It can also be possible to start at S58 by manually entering the CIN for example by using a key pad located outside of door 130 instead of using a smart card 111. It will be appreciated that one or more keypads 114 can be provided such as on the communications device 112 itself and or remotely therefrom to enable communication with CPU 118.

The CPU 118 checks at step S58 whether the CIN read from the card 111 or input manually is in the CIN list stored in the memory S138. If the answer is No the display 140 gives a warning message, S59, and the door release means 142 is not activated so an erroneous care worker can not enter the wrong client's house. The process still continues to step S64 so that the attempted entry can be recorded at the call centre 117. If the answer is Yes the door release means 142 is activated, S60, allowing the care worker access. The CPU 118 then checks if there is Scheduled Data (SD) on the card 111 which may have the time at which the carer planned to visit. If the planned time matches the current time on the clock, S66, then the expected departure time (ED) on the SD is written into the memory 138 of the device 112. Whether there is a matching SD or not the process continues to step S64.

At step S64 the CPU 118 communicates with the modem 126 to determine if the device 112 is connected to the PSTN 116. If this phone line is not connected then the CIN, ID, and arrival time are written into the NIA and it is recorded that a call attempt was not successful and not required. At step S72 the same information is written onto the CSA of the card 111 if it is present except that on the card 111 it is recorded that a call is required. The display then presents an OK message to the user, S74, and the process ends S76.

If the PSTN 116 is connected the CIN, ID and the time of arrival are written onto the NIA and it is recorded that a call attempt has been made but not yet been successful, S78, and the CSA is also written to the NIA, step S80, if the card 111 is present. The modem 126 is then connected to the PSTN 116 at step 82 and the device 112 attempts to detect a dial tone at step S84. If no dial tone is detected then a warning is given via display 140, step S86, and the modem is disconnected. The device 112 then pauses for a predetermined number of seconds (B) before checking at step S92 if the number of dial attempts (C) is greater than the preset number of dial attempts allowed (D). If the answer is yes the recording of a call attempt being required in the NIA is changed to not being required. and the process stops, S96. If the answer is no the process returns to S82 and the steps S84, to S92 are repeated until a dial tone is detected or the number of attempts (C) is greater than the number allowed D.

When a dial tone is detected the device 112 dials the CIN at step S98. In order for the call centre 117 to record the call it needs to be able to use Caller Line Identification (CLI). Some telephone lines are preset to prevent calls being identified so the device prefixes the CIN with the Caller ID Barred Removal Prefix (CIDP) which overrides this setting for the present call. Next the device 112 attempts to detect ring tones at step S100 and if not the process goes through steps S86 to S92. If ring tones are detected the modem 126 waits for a predetermined number of seconds (F) before disconnecting the modem at step 106. Before the modem disconnects a voicemail waiting signal may be displayed at step 104 if the call was disconnected before F seconds expired. That is, the call centre 117 may perform an automatic cancel of a call before F seconds is reached to indicate the presence of a message waiting and hence the cancellation of the call can be determined by the CPU 118 thereby to provide a signal to the user or carer of a message waiting. Finally, the ID arrival time are written onto the CSA of the card 111 along with recording that a call attempt was required and was successful, before the process stops at S110.

If at any point during the care workers visit the time is the same as the expected departure time (ED) then a “Time Up” message may be displayed to the user visa display 140 and preferably a buzzer 124 is activated.

The process of registering an end of a visit is shown in FIG. 7. Depending on the type of reader 120 used, registering an end of visit could happen by reswiping the card 111 or ejecting the card 111 if it is stored within the reader 120 during the visit. In one form, the communications device 112 can be provided with a slot to receive a smartcard 111, or other cradle for holding the same. In the circumstances that card 111 is inserted into device 112, optionally a manual and or electronically controlled eject mechanism is provided; so for example the end of a visit might be indicated by pressing an electronic button which effects ejection of card 111 and or a manually operated mechanical mechanism might also be provided to ensure that a carer retrieves his or her smartcard 111. Beneficially, retention of a smartcard 111 by a communications device 112 during a visit, enables accurate transfer of data between the card and device 112 and visa versa.

First the user requested the card be ejected or represents his/her card 111 at step 112. The time at which step 112 occurs i.e. the departure time is then recorded along with any Task List (TL) first to the NIA in device 112 then to the CSA in card 111 at steps 114 and 116. The TL is then cleared form the NIA, at step S118 and an OK message shown on display 140. At S122 the card is ejected or can be taken outside the range of reader 120.

At step S124 through to step S142 the device 112 checks if the phone line is connected, connects the modem 126 and checks for a dial tones then ring tones in substantially the same way as was done when the card 111 was detected in steps S64 to S100 shown in FIG. 6.

If ring tones are detected the process proceeds to step S144 when the modem 126 is disconnected. The call is recorded as being successful on the NIA at step S146 and the process finishes at step S148.

The process of dialling retrospective calls is shown in FIG. 8 that is the process of sending information to the call centre 117 that are not managed to be sent in the processes of FIG. 6 or 7.

Every time a predetermined number of seconds (E), S150, the device 112 checks if the phone line is connected at step S152. If the PSTN 116 is not connected then the process stops, S154.

If the PSTN 116 is connected then the CPU 118 checks at step S156 if there is any data stored in the NIA which has recorded that a call attempt is required but has not be successful. If the answer is no then no retrospective call is required and the process ends, S158. If the answer is yes the modem 126 is connected at step S160.

With the modem connected the device 112 attempts to detect a dial tone at step S162 If no dial tone is detected the modem is disconnected, at step S164, and the process ends at S165. If a dial tone is detected then the CIDP and CIN are dialled at step S166 and the device 112 waits for the call to be answered at step S168. If the call is not answered the process ends through steps S164 and S165 and if the call is answered the process proceeds to step S170. For retrospective calls the call must be answered and DNIS cannot be used because the event to be recorded is not happening in real time and so the call centre 117 requires the times at which the carer actually visited and left to be sent. Such information can be received by answering a call.

At step S170 the CIN, ID, and arrival and departure time can be sent as separated tones for example. An alternative would be to make a data call to another modem for example. The device 112 then waits for acknowledgement, S172, before the process ends S177.

The method of sending an alarm signal is shown in FIG. 9. After the radio wave is received at step S176 the device 112 checks if the phone line is connected S178 and has to stop, S180, if it is not.

If the device 112 is connected to the PSTN 116 then the modem is connected at step S182, and the device 112 attempts to detect a dial tone. If no dial tone is connected then the modem is disconnected at step S186 and the process stops S188. If a dial tone is connected then the Alarm CIN is called possibly with the CIDP. If the call is answered then the device 112 sends the ID and an Alarm Code so that the Alarm Call Centre knows from where the call originated. The process then finishes via step S186. As an alternative to this answered call system the Alarm Call Centre may use DNIS and the device 112 have its own unique alarm CIN which can then be identified through an unanswered call.

In another form of device 112, such a communications device can be provided to a user for example for location at the user's home or work place, remote from clients, thereby to enable a user to check work done or work scheduled. Accordingly, such a communications device beneficially comprises a display 114 and also other output features such as a printer. Indeed, such a device can comprise a means to enable a smartcard reader 122 to communicate with a smartcard 111 thereby to load data into a smartcard 111 such as revised scheduled data SD or even revised CIN. Beneficially therefore a user could access details related to client visits, hours of work done, amount of pay due and so on whereas an employer can pass data from the call centre 117 to the user to enable transfer of details of future work schedules and or visits.

Beneficially, the communications device 112 can also be adapted to interconnect a telephone with a PSTN and enable reaching of calls made by the telephone to a predetermined telecommunications network.

1. A communications device comprising a reader for reading a signal from a user, a communicator for generating a telephone call to a number, and a processor, in communication with the reader and communicator, adapted to instruct the communicator to call a specified number dependent on the signal received by the reader.

2. A communications device according to claim 1 wherein the reader is adapted to identify a signal representative of the specified number from a user input device such as a smart card.

3. A communications device according to claim 1 wherein the communicator comprises a modem.

4. A communications device according to claim 1 adapted to receive an incoming call via the communicator, thereby to enable acknowledgement of transmission of the outgoing call from the communications device.

5. A communications device according to claim 1 comprising a user output to indicate one or more of the following:
correct identification of an input signal from a user,
confirmation of transmission of an outgoing signal via the communicator in response to an input signal from a user,
confirmation of receipt of an incoming call acknowledging transmission of an earlier outgoing call from the communications device,
the end of a predetermined period, such as the end of a carer visit, as determined by the processor.

6. A communications device according to claim 1 which is adapted to be installed between a telephone and public service telephone network, such as in serial or parallel communication therewith.

7. A communications device according to claim 1 wherein the reader is adapted to read an electromagnetic signal from a user input device such as a card.

8. A communications device according to claim 1 wherein the reader is adapted to remotely read a signal from a user input device and/or wherein the signal is transferred from a user input device without contact with the reader.

9.-56. (canceled)

57. A communications device a according to claim 1 comprising a memory and an input device which enables a user to input data which stored in the memory and which input data is usable to determine the nature of a call to a specified number, thereby to enable transmission of a signal representative of the input data such as to indicate the nature of a task carried out by a carer.

58. A communications device according to claim 57 wherein the device is adapted to carry out one or more of the following in order to transmit the input data to a Call Centre:
a) Transmit a call to a specified number which is then answered and the data is transferred as part of the received call,
b) The input data is transmitted in the form of a representation of a preselected task so that it is the form of a number representing the task,
c) The nature of the call to a specified number is dependent on the input data such as the number of calls within a specified time period, and or the time delay between two consecutive calls is specified dependent on the nature of the input data.

59. A communications device according to claim 57 further comprising a clock in communication with a processor enabling a time or times to be associated with input data.

60. A communications device according to claim 57 wherein the input device comprises a keypad and the additional information comprises a series of numbers or letters typed by the user which correspond to activities.

61. A communications device according to claim 57 wherein a task list is stored in the memory of the device comprising a list of activities so that the carer can input/record additional information simply be selecting one of the listed activities and preferably pressing a key to confirm it has been completed.

62. A communications device according to claim 61 in which the task list can be downloaded to the device by the communicator.

63. A communications device according to claim 1 comprising a receiver, wherein the processor is adapted to instruct the communicator to call a specified number to raise an alarm when a specified signal is received by the receiver.

64. A communications device according to claim 63 further comprising an alarm device which when activated transmits the specified signal, wherein the signal transmitted corresponds to the temperature at the alarm device.

65. A communications device according to claim 63 further comprising a remote alarm device having a transmitter which alarm device when activated transmits the specified signal, the remote alarm device communicates the specified signal wirelessly to the receiver, and/or wherein the remote alarm device can form part of a smoke detector, burglar alarm, and or button actuated alarm device.

66. A communications device according to claim 63 wherein the communications device comprises a transmitter in communication with the processor and the remote alarm device comprises a loud speaker and microphone both in communication with the transmitter of the alarm device, allowing a use to talk through the alarm device to someone on a telephone that has received the call to the specified number.

67. A communications device according to claim 1 comprising a door release means in communication with the processor and connected to a door in use wherein release of the door in use by the door release means is dependent on the signal received by the reader.

68. A communications device according to claim 67 wherein release of the door in use in response to a signal received by the user is always accompanied by a call to a specified number.

69. A communications device according to claim 67 wherein the door is only released is use if the specified number called after the signal is received by the reader is in an allowed list of numbers held in a memory associated with the processor.

70. A communications device a according to claim 1 comprising two or more readers in communication with the processor.

71. A communications device according claim 1 wherein the device is switchable between a data call mode and an unanswered call mode, the specified number being dependent on whether the device is in the data call mode or the unanswered call mode with the generated call to a specified number in the unanswered call mode not needing to be answered in order for the time of call, and/or originating number of the call and/or the number called to be detected, and the generated call to a specified number in the data call mode is intended to be answered preferably by a modem/demodulator or communicator.

72. A communications device according to claim 71 wherein the mode of the device can be manually switched.

73. A communications device according to claim 71 wherein the device is automatically switched between modes depending on the determined nature of the call.

74. A monitoring system for monitoring incoming telephone calls routed through a call system, the system comprising a communications device according to claim 1 and a database, the system being adapted to detect the originating number of the call generated by the communicator and the specified number to which the generated call was made, and to store the time and date of an identified generated call and data representing the specified number.

75. A monitoring system according to claim 74 wherein the telephone calls are routed through a call transference system, the system being adapted to detect the originating number of the call generated by the communicator and the specified number to which the generated call was made before being transferred.

76. A monitoring system according to claim 74 further comprising call making means adapted to automatically generate a call in response to any generated call received from the communications device.

77. A monitoring system according to claim 74 the originating and called specified numbers of which are identified without answering the call generated by the communications device.

78. A monitoring system for monitoring incoming telephone calls routed through a calls system, the system comprising a communications device according to claim 1 and a database, the system being adapted to detect the originating number of a call generated by the communications device and to process the call dependent on the actual number of the received call, further comprising a call holding system which orders incoming calls in a queue based on predetermined criteria and wherein the queuing criteria depends on the area code of the incoming call and or the actual number of the incoming call.

79. A system according to claim 74, adapted to compare the number of an incoming generated call with stored numbers so as to match the parameters of an incoming call with a stored data to determine the origins of the call from which the call was made, and to compare the time and date of a matched number with a visit schedule stored on said database representing the expected times and dates at which callers should visit predetermined sites, the system adapted to compare the called number with a database of users stored in said data base so as to identify the caller/communications device.

80. A system according to claim 79, adapted to generate data indicating matched numbers and indicating compliance or not of the times and dates of matched numbers with the visit schedule.

81. A system according to claim 74 comprising a plurality of communications devices adapted to identify from which communications device a call was generated.

82. A system according to claim 81 in which the specified number is independent of the communications device from which a call to it is made, being dependent on the signal received by the reader and preferably also the mode of operation of the communications device.

83. A system according to claim 74 comprising a demodulator or second modem in communication with the database wherein a call generated by the communications device in the data call mode is answered by the demodulater/modem and the specified and originating numbers of a call generated by the communications device in the unanswered mode are identified without answering the call.

84. A communications device according to claim 79 in which the schedule data can be downloaded to the device by the communicator.

85. A communications device comprising a reader for reading a signal from a user, a communicator for generating a telephone call to a number, and a processor, in communication with the reader and communicator, adapted to instruct the communicator to call a specified number dependent on the signal received by the reader, wherein the device is switchable between a data call mode and an unanswered call mode, the specified number being dependent on whether the device is in the data call mode or the unanswered call mode with the generated call to a specified number in the unanswered call mode not needing to be answered in order for the time of call, and/or originating number of the call and/or the number called to be detected, and the generated call to a specified number in the data call mode is intended to be answered preferably by a modem/demodulator or communicator

86. A communications device comprising a reader for reading a signal from a user, a communicator for generating a telephone call to a number, and a processor, in communication with the reader and communicator, a memory and an input device which enables a user to input data which stored in the memory the system adapted to instruct the communicator to call a specified number dependent on the signal received by the reader, and wherein the input data is usable to determine the nature of a call to a specified number, thereby to enable transmission of a signal representative of the input data such as to indicate the nature of a task carried out by a carer, and a task list is stored in the memory of the device comprising a list of activities so that the carer can input/record additional information simply be selecting one of the listed activities and preferably pressing a key to confirm it has been completed.

87. A communications device comprising a reader for reading a signal from a user, a communicator for relaying a signal to a remote location, and a processor in communication with the reader and communicator adapted to instruct the communicator to contact a specified remote location preferably dependent on the signal received by the reader.
